(19) United States
(12) Patent Application Publication
(10) Pub. No.: US 2025/0023293 A1
(43) Pub. Date: Jan. 16, 2025

(54) CONNECTOR ASSEMBLY AND METHOD OF ASSEMBLING SUCH A CONNECTOR ASSEMBLY

(71) Applicant: Aptiv Technologies AG, Schaffhausen (CH)

(72) Inventors: Mélanie GUILLANTON, EPERNON (FR); Ked ZHAO, SHANGHAI (CN); Tanuraj BHATTACHARJEE, SILCHAR (IN); Laurent MORIN, RAMBOUILLET (FR)

(21) Appl. No.: 18/772,451

(22) Filed: Jul. 15, 2024

(30) Foreign Application Priority Data
Jul. 15, 2023 (EP) 23185705.3
Jul. 9, 2024 (EP) 24187357.9

(51) Int. Cl. H01R 13/621; H01R 13/622; H01R 24/28; H01R 24/76; H01R 43/26; H01R 105/00

(52) U.S. Cl. CPC H01R 13/6215; H01R 13/622; H01R 24/28; H01R 24/76; H01R 43/26; H01R 2105/00; H01R 2201/26

(57) ABSTRACT

The present invention discloses a connector assembly including a support, a connector with a housing for first electrical terminals, a counter-connector with a housing for second electrical terminals to mate with the connector and securing members for longitudinal securing. The support accommodates the connector, and the securing members include a first section to secure the connector to the support and a second section to secure the counter-connector to the connector. This assembly provides a reliable and efficient connection system for electrical terminals, enhancing stability and ease of use in various applications.

### CROSS-REFERENCE TO RELATED APPLICATION

This application claims the benefit of and priority to European Patent Application Nos. 23185705.3 titled “Connector Assembly and Method of Assembling such a Connector Assembly” filed on Jul. 15, 2023, and 241873597.9 titled “Connector Assembly and Method of Assembling such a Connector Assembly” filed on Jul. 9, 2024, the contents of each of which are incorporated by reference herein.

### TECHNICAL FIELD

This disclosure relates to the field of automotive connectors and, for example, to the field of power connectors for automotive applications.

### BACKGROUND

In recent years, the automotive sector has been facing a shift towards electric vehicles, such as cars. This is accompanied by an increasing number of electrical and electronic devices that need to be connected, which results in a rapid increase of electric cables and/or harnesses to facilitate provision of electrical connection. This increase of electric cables leads to an increased space occupied by them. Grommets are usually employed to guide electric cables through them and to protect them from potential environmental impacts.

There are connector assemblies including a connector (e.g., a header) and a counter-connector (e.g., a plug) to be mated to the connector, wherein the connector has a housing configured to be mounted to a support such as an appliance, a structural element of a vehicle, etc., Then, one or several screws may be used to secure the housing to its support, and another screw or several other screws may be used to secure the connector to the counter-connector.

Assembling these connectors therefore generally involves placing and screwing the connector onto its support, then placing and screwing the counter-connector onto the connector and/or the support. This type of connector assembly has drawbacks. For example, the room taken up by all the screws requires relatively large connector housings. Accordingly, there is a need for improving at least partially such connector assemblies and their assembly and mounting processes onto a support.

Various connector assemblies are known in the art for establishing electrical connections between electronic devices or components. These connector assemblies typically include a connector and a counter-connector that are configured to mate with each other to establish electrical communication. The connector housing of the connector accommodates one or more first electrical terminals, while the counter-connector housing of the counter-connector accommodates corresponding second electrical terminals that are designed to be connected to the first electrical terminals of the connector. The mating of the connector and counter-connector allows for the transmission of electrical signals or power between the connected devices.

In existing connector assemblies, securing the connector and counter-connector in place to ensure a stable and reliable connection can be a challenge. Conventional approaches often involve the use of separate securing mechanisms or fasteners that may require additional tools or complex installation procedures. These securing mechanisms may not provide optimal stability or may be prone to loosening over time, potentially leading to unreliable electrical connections. Furthermore, the design and arrangement of securing members in conventional connector assemblies may not always facilitate efficient and convenient assembly and disassembly of the connector components.

Efforts have been made in the prior art to address the challenges associated with securing connector assemblies effectively and efficiently. Some approaches have focused on enhancing the structural integrity of the connector housing or counter-connector housing to improve the stability of the connection. Other solutions have involved the use of additional locking mechanisms or latching features to secure the connector and counter-connector together. However, these conventional approaches may still have limitations in terms of case of assembly, disassembly, and overall reliability of the connector assembly. Therefore, there remains a need for an improved connector assembly that provides a comprehensive solution for securing the connector and counter-connector in a manner that ensures stable and reliable electrical connections. However, none of these approaches have provided a comprehensive solution that combines the features described in this disclosure.

### SUMMARY

A connector assembly is described below, which at least partially helps to overcome at least some of the drawbacks of the prior art. This connector assembly includes a support, a connector, a counter-connector and at least one securing member extending longitudinally along a securing direction. In this connector assembly the support is configured to receive the connector, the connector includes a connector housing to accommodate at least one first electrical terminal, and the counter-connector is configured to mate the connector and includes a counter-connector housing to accommodate at least one second electrical terminal configured to be connected to the at least one first electrical terminal.

Further, at least one securing member includes a first securing section configured to secure the connector onto the support and a second securing section configured to secure the counter-connector onto the connector.

Indeed, a same securing member (or fastening element) is used to both secure the connector onto the support and to secure the counter-connector onto the connector.

Therefore, instead of providing enough room in the connector for two different fastening elements (e.g., two different screws), i.e., one to secure the connector onto the support and one to secure the counter-connector onto the connector, it is sufficient to provide room for only one single fastening element. Of course, several securing members can be used for securing the connector, the counter-connector and the support together, but at least one securing member may replace two fastening elements.

This connector also optionally includes one and/or other of the following features, each considered independently of the other or in combination with one or more others:
the first securing section includes a first threaded portion configured to be screwed onto the support;
the second securing section includes a second threaded portion configured to be screwed with a nut to hold the counter-connector mated to the connector;
the at least one securing member includes a standoff section between the first and second securing sections;
the standoff section includes a nut section forming a single piece with the at least one securing member;
the standoff section includes a ring section configured to cooperate with the connector to hold the connector onto the support, the ring section forming a single piece with the at least one securing member;
the at least one securing member includes a free end located on a same side as the second threaded portion, the free end including a screwing structure whose shape is complementary to that of a spanner or screwdriver.
the counter-connector includes retaining means configured to retain a ring on which a nut is tightened when it is screwed onto the second threaded portion;
the retaining means captures the nut and holds the nut captive;
the connector may include a seal inserted between the connector housing and the support.

A method of assembling a connector assembly is also described below. This method of assembling a connector and a counter-connector with a support, includes the steps of:
placing the connector onto the support,
securing the connector onto the support with the help of at least one securing member,
placing the connector and the counter-connector so that at least one first terminal accommodated in the connector and at least one second terminal accommodated in the counter-connector are in a premating position, and so that the counter-connector is in a position relative to the at least one securing member, which is configured to engage a fastener on the at least one securing member,
securing a first securing section of the at least one securing member onto the support so as to secure the connector onto the support and securing the counter-connector onto the connector with the fastener engaged onto a second securing section of the at least one securing member.

Optionally, in this method, the fastener is a nut and the at least one first terminal and the at least one second terminal are connected while the nut is screwed on the at least one securing member.

### BRIEF DESCRIPTION OF THE DRAWINGS

Further features and advantages will become apparent in the detailed disclosure of an example embodiment of a connector assembly, as well as variations of this embodiment, this disclosure being accompanied by references to the accompanying drawings.

FIG. 1 shows an isometric view of a connector secured to a support according to some embodiments.

FIG. 2 shows a cross-section view of a portion of the connector and the support of FIG. 1 according to some embodiments.

FIG. 3 shows an isometric view of a connector assembly including a counter-connector secured onto the connector and the support illustrated in FIG. 1 according to some embodiments.

FIG. 4 shows a cross-section view of a portion of the connector assembly of FIG. 3 according to some embodiments.

### DETAILED DESCRIPTION

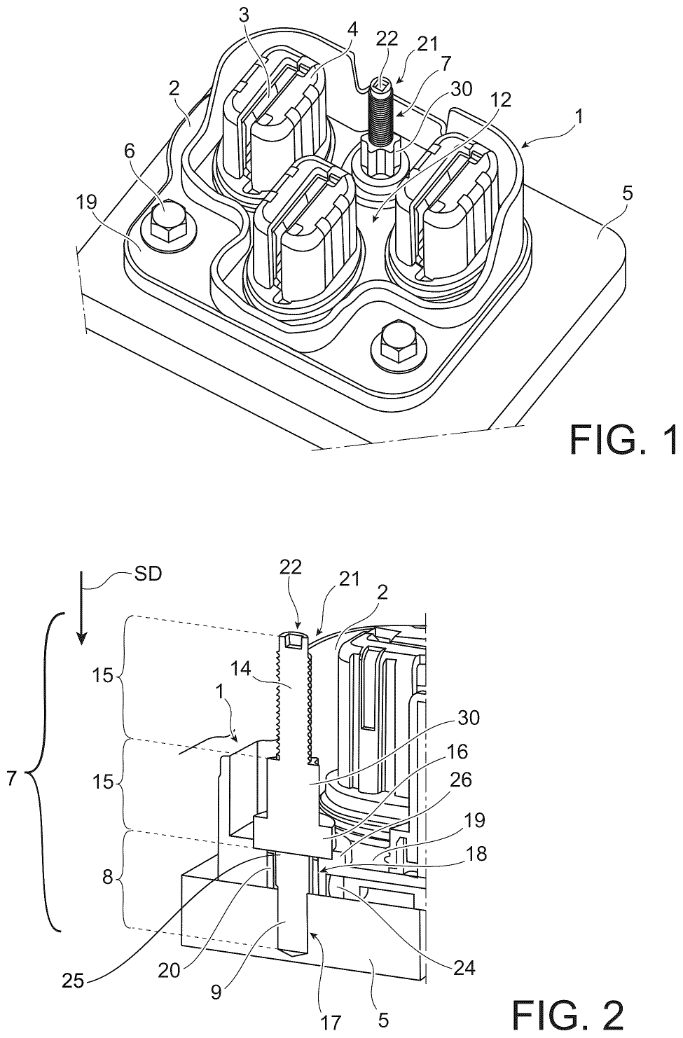

A non-limiting example of a connector 1 is shown in FIG. 1. This connector 1 is used for example in an electrical power circuit of a motor vehicle. Such a circuit is used, for example, to interconnect components such as a connection (bus) bar, a battery, a charging station, a converter, or an electric motor, etc.

In the illustrated example, the connector 1 is a header connector. The connector 1 includes a connector housing 2. In this example, the connector housing 2 accommodates three power terminals 3 (at least one of these power terminals 3 corresponds to the “at least one first electrical terminal recited in the claims). In the illustrated example, each power terminal 3 is protected by a cap 4. The housing 2 and the caps 4 are made, for example, of molded plastics (dielectric plastics). The power terminals 3 are made, for example, of a copper alloy (alternatively they are made of aluminum alloy or of another conductive material).

In this illustrated example, the housing 2 is secured on to a support 5 by two screws 6 and one securing member 7. In alternative embodiments, the number of screws 6 and/or securing members 7 may vary. The screws 6 are made, for example, of zinc-nickel plated steel. The securing member 7 is made, for example, of zinc-nickel plated steel. The securing member 7 is essentially positioned in a triangular area 12 left free between the three protection caps 4. In other words, the securing member 7 does not take up extra space in the connector 1, which would otherwise have required an increase of the size of the connector housing 2.

As shown in FIG. 2, the securing member 7 passes through a cylindrical passage 18 provided through a plate 19 of the connector housing 2. More particularly, the securing member 7 passes through a cylindrical standoff ring 20 inserted in the cylindrical passage 18. For example, the cylindrical standoff ring 20 is made of metal. Since the connector housing 2 is made of plastics, the cylindrical standoff ring 20 provides a reinforcement that prevents the housing plate 19 from breaking when the securing member 7 clamps the connector 1 onto the support 5. The securing member 7 includes a first securing section 8 configured to secure the connector 1 onto the support 5. In the illustrated example, the first securing section 8 includes a first threaded portion 9. The first threaded portion 9 is at least partially screwed into a complementary threaded hole 17 of the support 5.

In alternative embodiments, the first securing section 8 includes any securing means which is/are configured to secure the connector 1 to the support 5. For example, such securing means can be configured to be inserted in force or press-fit in a hole, to cooperate with a self-retaining ring, etc.

The securing member 7 further includes a second securing section 13. In the illustrated example, the second securing section 13 includes a second threaded portion 14. In alternative embodiments, the second securing section 13 includes any securing means which is/are configured to secure the connector 1 and a counter-connector 10 to each other. For example, such securing means may consist of complementary snapping means, latching means, locking means, etc.

In the illustrated example, the securing member 7 includes a standoff section 15 between the first 8 and second 13 securing sections. In the illustrated example, the standoff section 15 includes a nut section 30 configured to screw the securing member 7, in the support 5, on the plate 19. The nut section 30 can have any suitable shape for tightening the securing member 7 onto the support 5 (e.g., a hexagonal or hexalobular shape), the standoff section 15 includes a ring section 16. The ring section 16 is configured to cooperate with the connector housing 2 (e.g., the plate 19 of the connector housing 2) to hold the connector 1 onto the support 5.

The ring section 16 is formed as a single piece with the remaining sections 8, 15, and 13 of the securing member 7. The ring section 16 rests on the cylindrical standoff ring 20 and/or on an annular surface of the connector housing 2, which surrounds the cylindrical passage 18. In the illustrated example, this annular surface is itself surrounded by an annular rib 26. The rib 26 guides the ring section 16 and ensures a precise positioning of the connector 1 on the support 5. The rib 26 is also located above a seal 24 surrounding a region of the plate 19 including the terminals 3 of the connector 1. The rib 26 then acts as a reinforcing structure which ensures that the plate 19 is flat and that there is a good seal between the plate 19 and the support 5.

The ring section 16 is thick enough (in a direction parallel to the longitudinal direction of the securing member 7, which also corresponds to a securing direction SD when the assembly is performed) so that an alignment structure 29 of the plug or counter-connector 10 can be guided by the ring section 16, when the counter-connector 10 is mated with the connector 1 (see FIG. 4).

The securing member 7 includes a free end 21 located on a same side as the second threaded portion 14 (see FIG. 2). The free end 21 includes a screwing structure 22 whose shape is complementary to that of a tool, such as a wrench or screwdriver.

In summary, the securing member 7 extends longitudinally between two free ends and includes: the first threaded portion 9, an intermediate portion 25, the ring section 16, the standoff section 15, the second threaded portion 14 and the free end 21 including the screwing structure 22 extending from a free end to the other. All these portions and sections form a single piece. This provides the advantage of simplifying the assembly process of the connector 1 and the counter-connector 10 onto the support 5. This also simplifies the sourcing and supply chain management because there are fewer parts to manage.

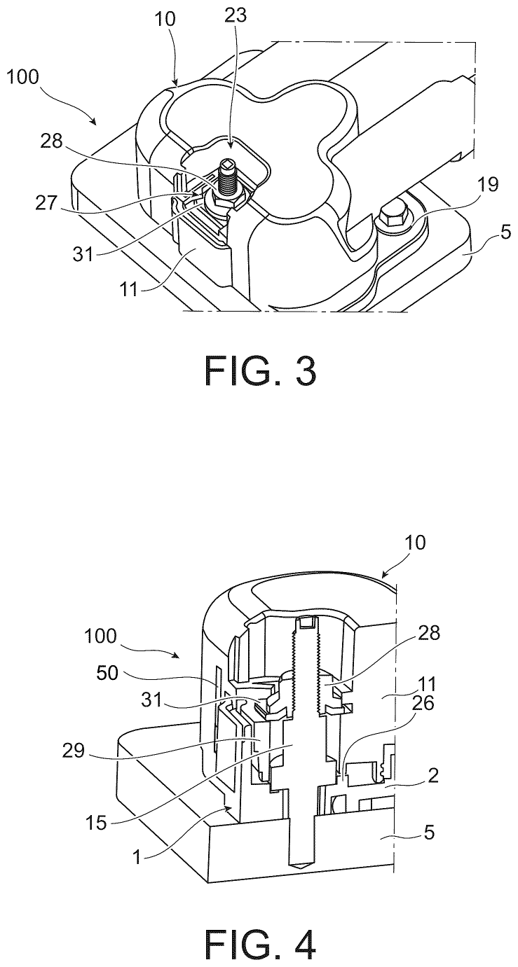

As shown in FIG. 3, the counter-connector 10 is mounted on the connector 1. The counter-connector 10 includes a counter-connector housing 11. In the illustrated example, the counter-connector 10 is a plug connector (e.g., a female connector). The counter-connector 10 is a cable connector. It accommodates three power terminals (not shown), each electrically and mechanically connected to a cable. The cables extend perpendicular to the mating direction. The cables are power cables with a relatively large section. The cables are relatively stiff and heavy.

As shown in FIG. 3, the counter-connector 10 includes a hollow portion 23. The hollow portion 23 is essentially located in a region corresponding, in the connector 1, to the triangular area 12.

A ring 31 is mounted on the counter-connector 10. The counter-connector 10 has retaining means 27 to retain the ring 31. For example, the ring 31 has a rectangular plate-like shape configured to be guided when inserted onto the counter-connector 10. The ring 31 has an internal shape around a hole so as to enable the retention of a nut 28 on the ring 31 after a specific crimping. The retaining means 27 is/are flexible so as to facilitate the insertion of the ring 31 and the nut 28 onto the counter-connector 10, in one direction (a chamfered portion helps the insertion), and so as to make it more difficult to remove it in the opposite direction. The retaining means 27 hold the ring 31 and the nut 28 captive. Therefore, the ring 31 and the nut 28 are mounted and held on the counter-connector 10. For example, the counter-connector 10 is supplied by a harness maker (i.e., the manufacturer carrying out the assembly of the cables with the terminals, as well as the mounting of the terminals in the counter-connector 10). This is an advantage in that there is no risk of the nut 28 being lost. It also simplifies the supply chain, as there are fewer separate elements to manage. The nut 28 is screwed on the second threaded portion 14 and tightened on the ring 31 (alternatively any other appropriate fastening means may be used instead of the nut 28 and the threaded portion 14). The nut 28 and the ring 31 are located in the hollow portion 23 so that they do not clutter the environment of the connector assembly 100.

As shown in FIG. 4, the standoff section 15 blocks the ring 31 and the nut 28 and therefore discourages the connector housing 2 from being deformed and/or broken. On the one hand, as mentioned above, the counter-connector 10 (with its cables, terminals, ring 31 and nut 18) can be prepared by a harness maker. On the other hand, the connector 1 can be directly supplied to the car manufacturer. In other words, the car manufacturer can be supplied with the connector 1 and the securing member 7 by the manufacturer of the connector 1 and can be supplied with the counter-connector 10 by a harness maker. The assembly of the connector 1 to the counter-connector 10 is then quite easy for the car manufacturer.

The following steps are carried out for assembling the connector 1 and the counter-connector 10 on the support 5:
placing the connector 1 onto the support 5,
securing the connector 1 onto the support 5 with the help of the securing member 7 and the screws 6,
placing the connector 1 and the counter-connector 10 so that the terminals of the connector 1 and the counter-connector 10 are aligned in a premating position, and so that the counter-connector 10 is in a position relative to the securing member 7, which is configured to engage the nut 28 on the securing member 7,
screwing the nut 28 on the second threaded portion 14 so as to clamp the connector housing 2 and the counter-connector housing 11 between the support 5 and the ring 31.

Screwing the nut 28 on the second threaded portion 14 assists the mating of the connector 1 and counter-connector 10, and their respective terminals. So as to help the connector 1 and counter-connector 10 to be well aligned before and during screwing the nut 28 on the second threaded portion 14, the connector 1 and counter-connector 10 have complementary sliding means 50. The sliding means 50 acts as a “third hand”. Indeed, as the cables are stiff and heavy, the sliding means 50 helps maintaining the connector 1 and counter-connector 10 in a premating position before the above-mentioned screwing step and helps aligning the connector 1 and counter-connector 10 so as to case the screwing and to avoid damaging the respective threads of the nut 28 and the second threaded portion 14.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly, comprising:
a support;
a connector having a connector housing configured to accommodate at least one first electrical terminal;
a counter-connector configured to mate with the connector and having a counter-connector housing configured to accommodate at least one second electrical terminal configured to be connected to the at least one first electrical terminal; and
at least one securing member extending longitudinally along a securing direction, the support being configured to receive the connector, the at least one securing member comprising a first securing section configured to secure the connector onto the support and a second securing section configured to secure the counter-connector onto the connector.

2. The connector assembly according to claim 1, wherein the first securing section comprises a first threaded portion configured to be screwed onto the support.

3. The connector assembly according to claim 1, wherein the second securing section comprises a second threaded portion configured to be screwed with a nut to hold the counter-connector mated to the connector.

4. The connector assembly according to claim 3, wherein the at least one securing member comprises a free end located on a same side as the second threaded portion, the free end comprising a screwing structure whose shape is complementary to that of a tool.

5. The connector assembly according to claim 4, wherein the tool comprises a wrench.

6. The connector assembly according to claim 4, wherein the tool comprises a screwdriver.

7. The connector assembly according to claim 3, wherein the counter-connector comprises retaining means configured to retain a ring on which a nut is tightened when it is screwed onto the second threaded portion.

8. The connector assembly according to the claim 7, wherein the retaining means is configured to capture the nut.

9. The connector assembly according to claim 1, wherein the at least one securing member comprises a standoff section between the first and second securing sections.

10. The connector assembly according to claim 9, wherein the standoff section comprises a nut section forming a single piece with the at least one securing member.

11. The connector assembly according to claim 10, wherein the standoff section comprises a ring section configured to cooperate with the connector to hold the connector onto the support.

12. The connector assembly according to claim 11, wherein the ring section forming a single piece with the at least one securing member.

13. The connector assembly according to claim 1, comprising a seal inserted between the connector housing and the support.

14. A method of assembling a connector and a counter-connector with a support, comprising;
placing the connector onto the support;
securing the connector onto the support via at least one securing member;
placing the connector and the counter-connector so that at least one first terminal accommodated in the connector and at least one second terminal accommodated in the counter-connector are in a premating position, and so that the counter-connector is in a position relative to the at least one securing member, which is configured to engage a fastener on the at least one securing member; and
securing a first securing section of the at least one securing member onto the support so as to secure the connector onto the support and securing the counter-connector onto the connector with the fastener engaged onto a second securing section of the at least one securing member.

15. The method according to claim 14, wherein the fastener is a nut.

16. The method according to claim 15, wherein at least one first terminal and the at least one second terminal are connected while the nut is screwed on the at least one securing member.
